(19) United States
(12) Patent Application Publication
(10) Pub. No.: US 2017/0171719 A1
(43) Pub. Date: Jun. 15, 2017

(54) INFORMATION PROCESSING APPARATUS, INFORMATION PROCESSING METHOD, AND RECORDING MEDIUM STORING INFORMATION PROCESSING PROGRAM

(71) Applicant: Norikazu IGARASHI, Kanagawa (JP)

(72) Inventor: Norikazu IGARASHI, Kanagawa (JP)

(21) Appl. No.: 15/370,880

(22) Filed: Dec. 6, 2016

(30) Foreign Application Priority Data
Dec. 9, 2015 (JP) 2015-239848

(51) Int. Cl. H04W 4/04; H04W 40/24

(52) U.S. Cl. CPC H04W 4/043; H04W 40/244; G06F 3/0482

(57) ABSTRACT

An information processing apparatus includes a receiver that receives position information indicating a position of a beacon device located inside a building, the beacon device including a first beacon device that transmits first position information and a second beacon device that transmits second position information, the second beacon device having narrower directivity compared to the first beacon device, a sensor that detects a current position of the information processing apparatus, and circuitry that acquires, in response to user operation for specifying a target destination, position coordinates of the target destination and a way how to get to the target destination, measures the current position of the information processing apparatus using the first position information, updates the current position of the information processing apparatus using pedestrian dead reckoning (PDR), based on detection of the sensor, and corrects altitude information of the current position using the second position information.

### CROSS-REFERENCE TO RELATED APPLICATION

This patent application is based on and claims priority pursuant to 35 U.S.C. §119(a) to Japanese Patent Application No. 2015-239848, filed on Dec. 9, 2015 in the Japan Patent Office, the entire disclosure of which is hereby incorporated by reference herein.

### BACKGROUND

Technical Field

The present invention relates to an information processing system, an information processing method, and a non-transitory recording medium storing an information processing program.

Background Art

Recently, car navigation devices and communication devices such as smartphones have become popular as devices that provide position information services using a global positioning system (GPS). In using GPS, satellite radio waves are used. Therefore, the devices using GPS cannot provide position information services in places where the radio waves do not reach, such as indoor areas and underground areas.

To cope with this issue, in the known system, multiple beacon devices that communicate using iBeacon (registered trademark) may be located at indoor areas and underground areas. The communication apparatus calculates user position information based on signals received from the beacon devices, which include information indicating beacon location. In addition, a positioning system using pedestrian dead reckoning (PDR) that specifies a pedestrian position by using various sensors included in the smartphones such as motion sensors and pressure sensors etc., is known.

In existing communication apparatuses that calculate pedestrian position information using beacon devices, in moving through multiple floors using elevators, or using indoor escalators or stairs at vaulted areas, it has been difficult to detect a current position based on intensity of radio waves of the beacon device to precisely specify on which floor the user is located. As a result, an indoor floor map displayed on the communication apparatus is not switched according to the user position, and it is difficult to navigate the user to an intended destination. In addition, just by using PDR, the errors in measurement will be accumulated as the pedestrian moves on, and it is difficult to navigate the pedestrian to an intended destination.

### SUMMARY

Example embodiments of the present invention provide a novel information processing apparatus that includes a receiver that receives position information indicating a position of a beacon device located inside a building, the beacon device including a first beacon device that transmits first position information and a second beacon device that transmits second position information, the second beacon device having narrower directivity compared to the first beacon device, a sensor that detects a current position of the information processing apparatus, and circuitry that acquires, in response to user operation for specifying a target destination, position coordinates of the target destination and a way how to get to the target destination, measures the current position of the information processing apparatus using the first position information transmitted by the first beacon device, updates the current position of the information processing apparatus using pedestrian dead reckoning (PDR), based on detection of the sensor, and corrects altitude information of the current position using the second position information transmitted by the second beacon device.

Further example embodiments of the present invention provide a method of processing information and a non-transitory recording medium storing an information processing program.

### BRIEF DESCRIPTION OF THE DRAWINGS

A more complete appreciation of the disclosure and many of the attendant advantages thereof will be readily obtained as the same becomes better understood by reference to the following detailed description when considered in conjunction with the accompanying drawings.

FIG. 1 is a diagram illustrating a navigation system as an embodiment of the present invention;

FIG. 2 is a block diagram illustrating a hardware configuration of an information processing apparatus as an embodiment of the present invention;

FIG. 3 is a block diagram illustrating a functional configuration of the information processing apparatus as an embodiment of the present invention;

FIG. 4 is a flowchart illustrating a process performed by the information processing apparatus as an embodiment of the present invention;

FIG. 5 is a diagram illustrating a graphical user interface (GUI) displayed by the information processing apparatus as an embodiment of the present invention;

FIG. 6 is a diagram illustrating a screen that a two-dimensional bar-code such as QR code is displayed as an embodiment of the present invention;

FIG. 7 is a diagram illustrating a screen that the QR code in frame is scanned by user operation as an embodiment of the present invention, and

FIG. 8 is a diagram illustrating a data structure of building information stored in a building information storing unit as an embodiment of the present invention.

The accompanying drawings are intended to depict example embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

A more complete appreciation of the disclosure and many of the attendant advantages thereof will be readily obtained as the same becomes better understood by reference to the following detailed description when considered in conjunction with the accompanying drawings.

Embodiments of the present invention are described below in detail with reference to figures. In figures, same symbols are assigned to same or corresponding parts, and their descriptions are simplified or omitted appropriately.

In the embodiment described below, an image processing system is described as an example of managing a cache in multi-threading. However, the embodiment can be applied to various systems that manages a cache in multi-threading.

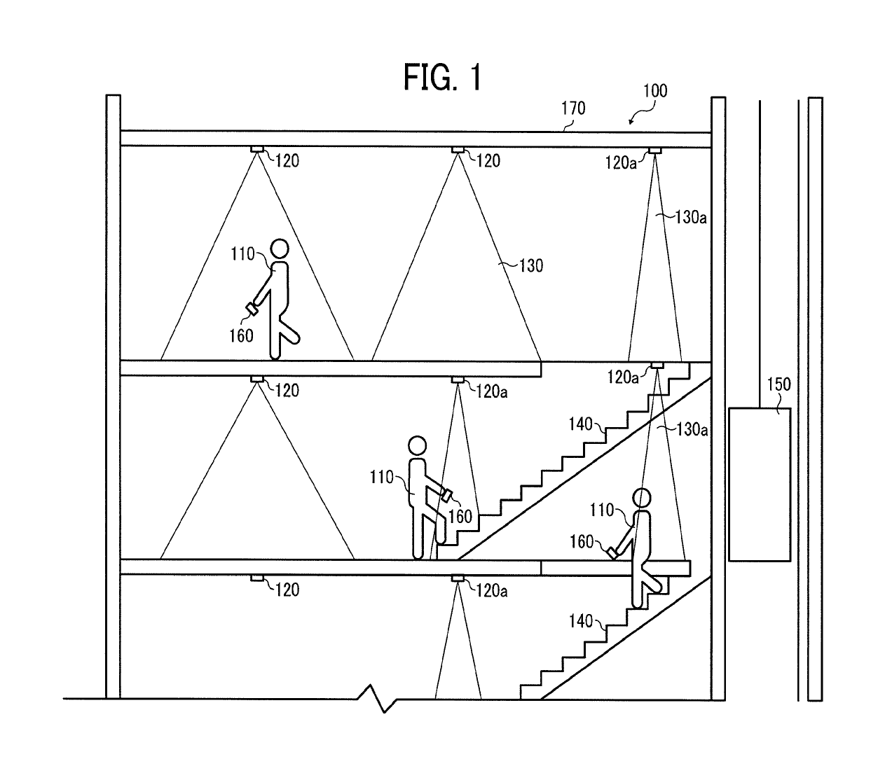

FIG. 1 is a diagram illustrating a navigation system in this embodiment. In FIG. 1, a user 110 carries an information processing apparatus 160 and moves in a building 170. In the building 170, multiple beacon devices 120 that transmit information for causing location information be acquired, are located at appropriate places such as a ceiling etc. For example, the user 110 carries the information processing apparatus 160 such as a personal data assistant (PDA), smartphone, tablet device, and dedicated device etc. and moves in the building 170.

The user 110 may move on foot using stairs 140 or may move to an intended destination using a transport apparatus such as an elevator 150 and an escalator etc. In moving to a different floor, conventionally, it is detected that the user 110 moves to the different floor using information received from a pressure sensor etc. included in the information processing apparatus 160. However, it is difficult to precisely estimate altitude by using information received from the pressure sensor.

In this embodiment, to reflect the change in altitude due to the transfer of the user 110 on a specific floor in the building 170, beacon devices 120a as second beacon devices that have narrow directivity ranges 130a, are located at areas around stairs, escalators, and elevator doors, that is, the areas where the user 110 approaches when the user moves to different floors. In addition, in this embodiment, beacon devices 120 as first beacon devices that have wider directivity areas, are located separately to estimate locations using PDR and determine a floor where the user 110 exists more precisely.

The beacon devices 120 and 120a transmit information such as their own location information, identification information, and communication conditions like radio wave intensity etc. using infrared communication, wireless communication, or sonic wave etc. within their directivity ranges 130 and 130a, respectively. As illustrated in FIG. 1, in this embodiment, the beacon devices 120a that have narrower directivity are located at areas where the user approaches to access different floors in the building 170. The beacon devices 120 that have wider directivity are located at other areas.

By setting the directivity narrow, the information processing apparatus 160 is able to precisely acquire altitude information corresponding to floors. In this embodiment, the areas where the user approaches to access different floors in the building 170 indicates areas such as an entrance of stairs, an exit of stairs, an entrance of escalators, an exit of escalators, an entrance of elevators, and an exit of elevators etc. for example.

The information processing apparatus 160 updates a current location using PDR. Subsequently, for example, if the information processing apparatus 160 receives information from different beacon devices 120 and 120a, the current location calculated using PDR is corrected using location information acquired using information newly received from the beacon devices 120 and 120a.

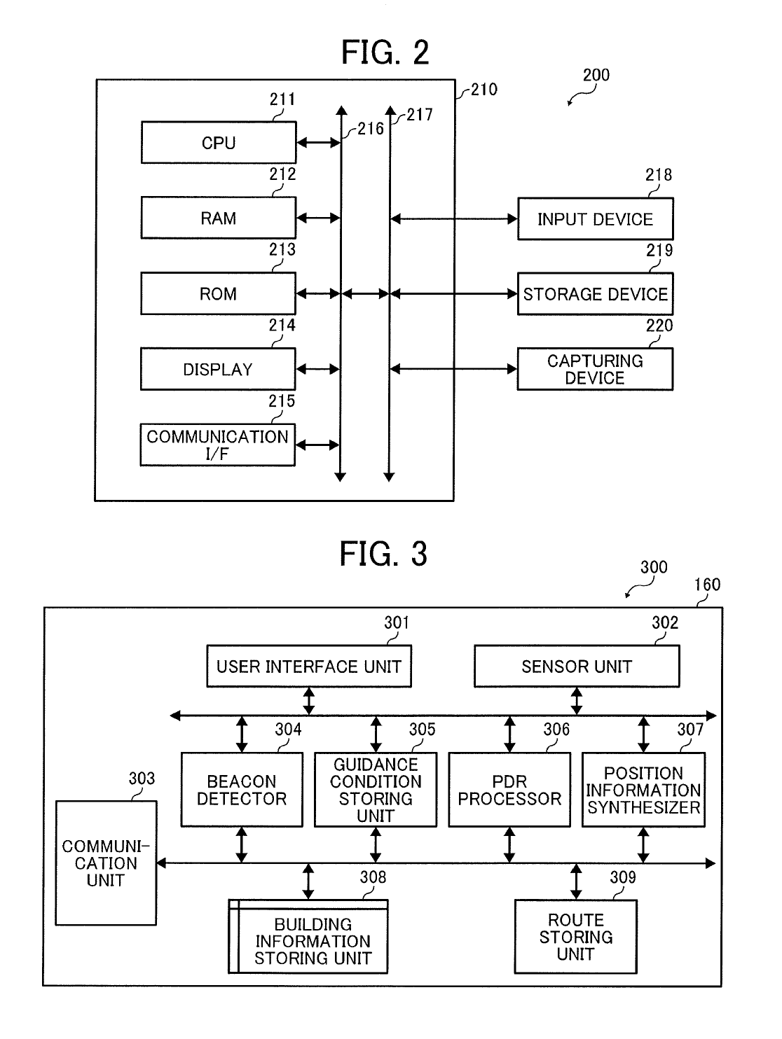

FIG. 2 is a block diagram illustrating a hardware configuration of the information processing apparatus 160 in this embodiment. The information processing apparatus 160 includes a central processing unit (CPU) 211, a random access memory (RAM) 212, a read only memory (ROM) 213, a display 214, and a communication interface (I/F) 215 connected with each other via a system bus 216. Furthermore, an I/O bus 217 is connected to the system bus 216 via a bus bridge such as PCI and PCI Express etc. In addition, input devices 218 such as a touch panel etc., a memory 219 such as a hard disk drive (HDD) and a memory card etc., and a capturing device 220 such as a camera etc. are connected to the I/O bus 217 via an appropriate protocol.

More specifically, examples of the CPU included in the information processing apparatus 160 are Pentium (registered trademark), Pentium IV (registered trademark), Pentium-compatible CPUs, Power PC (registered trademark), MIPS, Tegra (registered trademark), Snapdragon (re), and Hello (registered trademark) etc.

Examples of an operating system (OS) included in the information processing apparatus 160 are MacOS (trademark), iOS (registered trademark), Windows (registered trademark), Chrome (registered trademark), Android (registered trademark), Windows (registered trademark) 200X Server, UNIX (registered trademark), AIX (registered trademark), Linux (registered trademark), and other appropriate OSs. Furthermore, in the information processing apparatus 160, application programs written in program languages such as C, C++, Visual C++, Visual Basic, Java (registered trademark), Perl, and Ruby etc. running on the OS described above are stored and executed.

FIG. 3 is a block diagram illustrating a functional configuration of the information processing apparatus 160 in this embodiment. The information processing apparatus 160 executes programs in this embodiment using the hardware resources illustrated in FIG. 2 and controls the hardware resources to function as functional units illustrated in FIG. 3. The information processing apparatus 160 includes a communication unit 303. The communication unit 303 provides a function that connects to the Internet etc. using communication protocols such as IEEE 803.11x etc. In addition, the communication unit 303 provides a function that communicates with the beacon device 120 bi-directionally using infrared communication, optical communication, and wireless communication etc. In addition, the communication unit 303 may include a function that can acquire information using near field radio communication such as RFID etc.

Furthermore, the information processing apparatus 160 includes a user interface unit (UI unit) 301 and a sensor unit 302. The UI unit 301 corresponds to a liquid crystal display (LCD) and a touch sensor (the display 214 in FIG. 2), which receives input from the user 110, and presents a processing result of the information processing apparatus 160 to the user 110 via the LCD. The sensor unit 302 corresponds to various sensors such as a motion sensor, a pressure sensor, and a GPS sensor etc. The motion sensor including an acceleration sensor and a gyro-sensor etc. detects motion of the information processing apparatus 160 and measures its own current location. As the information processing apparatus 160 moves along the user 110, the sensor unit 302 sends information detected by the motion sensor etc. to the PDR processor 306 and estimates a moving distance of the information processing apparatus 160 along with the move of the user 110

Furthermore, the information processing apparatus 160 includes a beacon detector 304, a guidance condition storing unit 305, and a PDR processor 306. The beacon detector 304 detects a beacon signal in this embodiment and detects the beacon signal as information for acquiring location information associated with the beacon devices 120 and 120a by communicating between the communication unit 303 and the beacon device 120. Subsequently, the beacon detector 304 acquires an identification value of the beacon device 120 etc. from the detected beacon signal. The acquired identification value is sent to the PDR processor 306 and used for correcting the current location calculated by PDR.

The guidance condition storing unit 305 stores a guidance condition in this embodiment. The guidance condition storing unit 305 searches for positions of stores, facilities, rest areas, smoking areas, water points, vending machines, bath rooms, and chargers for mobile devices etc. in response to interactive operations by the user 110 and stores such information in a memory such as the RAM 212. Examples of acquisition of location information on target destinations are described below. (1) The user 110 inputs text via the UI unit 301. (2) The target destination is selected from a store list included in a downloaded application. (3) The target destination is acquired from a two-dimensional code using the camera included in the information processing apparatus 160. (4) The target destination is acquired by inputting the name of the store using user voice. (5) The target destination is acquired by acquiring three-dimensional information of the building 170 such as stores and facilities etc.

The guidance condition storing unit 305manages an order of guidance, when multiple target destinations are set. If multiple target destinations are input by user operation, the target destinations are set in first-come first-served basis and navigate the user to multiple target destinations in this order.

Furthermore, the guidance condition storing unit 305 may store indicating how to get to the target destination specified by the user, e.g., by using the elevator, by using the escalator, or by using stairs.

The PDR processor 306 performs PDR in this embodiment and estimates the current location of the information processing apparatus 160 by adopting PDR using information received from the motion sensor and the pressure sensor. After the beacon detector 304 detects any one of the beacon devices 120 and 120a that have a new identification value, the PDR processor 306 corrects information on the current location calculated by the PDR processor 306 using the identification value of the beacon device 120 or the beacon device 120a.

In this case, the beacon device 120 or the beacon device 120a may send the identification value itself of the beacon device 120 or the beacon device 120a as the information for acquiring its own location information. Otherwise, the beacon device 120 or the beacon device 120a may send the three-dimensional coordinates in the building 170 where the beacon device 120 or the beacon device 120a is located as the information for acquiring its own location information. In case of reporting the location information by sending the identification value of the beacon device 120 or the beacon device 120a, for example, the PDR processor 306 refers to beacon location information associating the identification value of the beacon with three-dimensional location coordinates. After the reference, it is possible to acquire the three-dimensional location coordinates of the corresponding beacon and correct the current location calculated using PDR.

Furthermore, the information processing apparatus 160 includes a building information storing unit 308 and a route storing unit 309. The building information storing unit 308 stores building information in this embodiment. The building information storing unit 308 stores identification information of stores such as store names etc. on each floor in the building 170, their three-dimensional location coordinates, and floor maps of each floor as images. In the map image, three-dimensional location coordinates on each floor are associated with pixels or pixel areas that construct the map image, and it is possible to superimpose the current location acquired using PDR and the position of the beacon device 120 on the map image.

The building information storing unit 308 may preliminarily download the three-dimensional location positions and map images etc. from a server via the Internet and store the information in the RANI 212. In addition, after the user enters into the building 170, by sending the building information to the information processing apparatus 160 using pushing communication by a server dedicated to the building 170, it is possible to obtain the building information.

The route storing unit 309 stores route information in this embodiment. The route storing unit 309 stores routes from the current location to the target destination for each floor, which is calculated preliminarily in accordance with the way how to get to the target destination depending on selection of the current location, the target destination, and the way how to get to the target destination etc. It is unnecessary that the information processing apparatus 160 stores all of the routes. Instead, after the user current location, target destination, and the way how to get to the target destination are determined, it is possible to specify and download required routes from a server using the Internet or near field radio communication etc. The routes may be determined in various ways. Preferably, the shortest route is prepared.

Furthermore, the information processing apparatus 160 may include a position information synthesizer 307 that synthesizes position information in this embodiment. Preferably, the position information synthesizer acquires a floor map of the floor where the user 110 exists from information of the current position. Subsequently, after acquiring a route image from the route storing unit 309, the route image and the current position calculated by the information processing apparatus 160 are superimposed on the floor map to display the current position using an appropriate character. In addition, the position information synthesizer 307 may display the target destination on the floor map using an appropriate character and an appropriate color scheme pattern etc.

In this embodiment, altitude where the user 110 exists, i.e., a floor where the user 110 exists in this embodiment, is determined using position coordinates associated with the beacon device 120a. As a result, it is possible to prevent a problem that the floor map of the current floor is unstably changed due to a noise of altitude information received from the pressure sensor, for example.

Consequently, on the information processing apparatus 160, the LCD panel of the UI unit 301 displays the floor map, the target destination, the current position, and the route are. The user 110 moves to the target destination in the building 170 with reference to the image displayed on the information processing apparatus 160. In other embodiments, regarding the current position of the user 110, by displaying a mark indicating a direction of the information processing apparatus 160 to the closest beacon devices 120 and 120a etc., it is possible to navigate the user 110 to the routing direction.

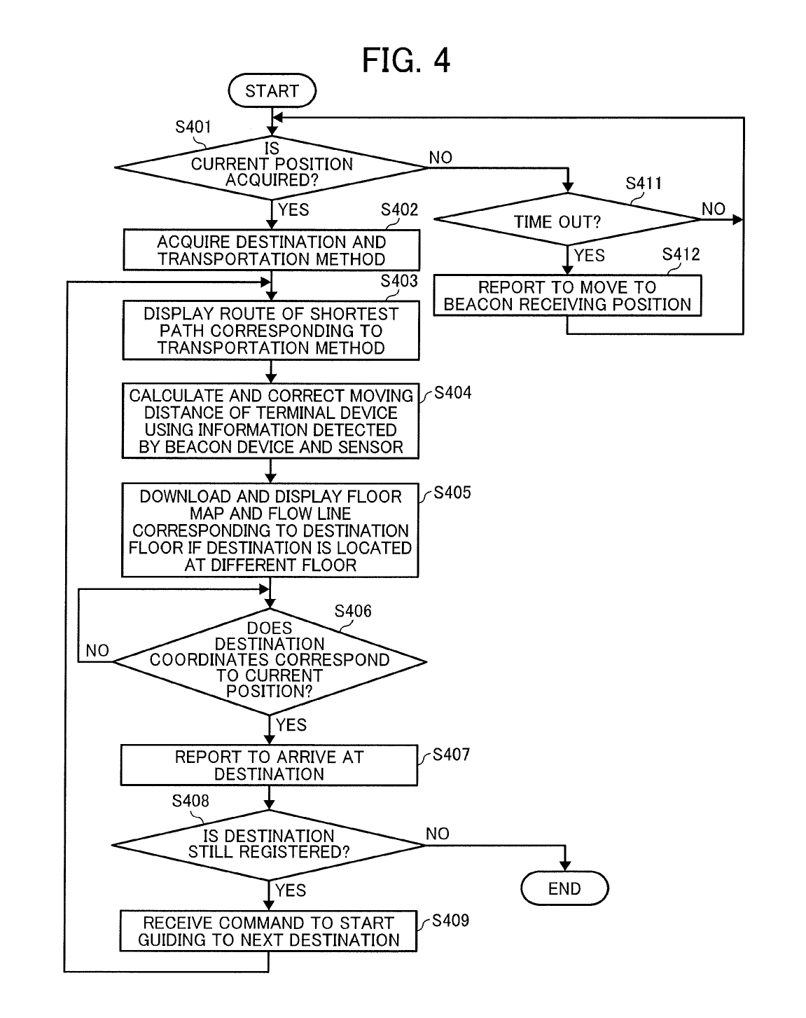

FIG. 4 is a flowchart illustrating an operation performed by the CPU 211 in the information processing apparatus 160 in this embodiment. After starting the operation in FIG. 4, it is determined whether or not the current position is acquired in S401. In this embodiment, the current position is acquired by communicating with the beacon devices 120 and 120a. Therefore, if the information processing apparatus 160 cannot communicate with the beacon devices, it is impossible to acquire the current position. If the current position is not acquired (NO in S401), it is tried to acquire the current position until a predetermined period of time runs out in S411. After the predetermined period of time runs out in S411, the user is suggested to move to a position where a beacon may be received using the LCD or a voice.

By contrast, if the current position is acquired (YES in S401), the target destination and the way how to get to the target destination is acquired in response to user operation in S402. The target destination may be acquired by inputting text, inputting voice, or decoding a two-dimensional code etc. by user operation. In response to the user input, the information processing apparatus 160 converts the target destination into three-dimensional coordinates and store the information in the guidance condition storing unit 305.

Subsequently, while the sequence is not limited, the way how to get to the target destination is specified by user 110′s operation. The guidance condition storing unit 305 may store the way how to get to the target destination and acquire the route to the target destination after the position information synthesizer 307 refers to the route storing unit 309.

In S403, with reference to the current position, the target destination, and the way how to get to the target destination, information on the route (i.e., the shortest route in a preferable embodiment) corresponding to the way how to get to the target destination is downloaded and stored in the route storing unit 309. Subsequently, the route corresponding to the current floor may be displayed by superimposing the route on the floor map of the current floor. To determine the route to the target destination, it is possible to generate the route by calculating routes between the identification value of the beacon device 120 at the current position and the beacon device 120 located closest to the target destination by using round-robin algorithm. The generated route may be rasterized and stored in the server associated with each other such as a pair of floor, beacon 1, and beacon 2 etc. In this case, the beacon 1 indicates the identification value of the beacon device 120a located at the entrance area to the floor, and the beacon 2 indicates the identification value of the beacon device 120 located where a position that represents the target destination.

It is unnecessary that the mobile information processing apparatus 160 stores all route information calculated using round-robin algorithm. The route information is determined uniquely by specifying the current position, the target destination, and the way how to get to the target destination. Therefore, it is possible to perform the operation effectively by just acquiring routes on required floors for the required number of floors. Among the routes, stairs, escalators, or elevators are used for routes while the user moves vertically. Therefore, it is possible to display a floor level using a vertical bar or a numerical value etc.

In this embodiment, in addition to the motion sensor, the floor level is determined using the association between the identification value of the beacon device 120 and the floor where the beacon device 120 is located. Therefore, even if the user moves through multiple floors, it is possible to display the appropriate floor map effectively and provide the navigation system with high-operability.

In S404, by using the information detected by the beacon device and the sensor, the moving distance of the information processing apparatus 160 is estimated, and the current position is updated. As the user 110 moves along, if a beacon signal from the new beacon devices 120 and 120a are received, the PDR processor 306 corrects the current position using the position information received from the beacon devices to calibrate the current position. It is possible to correct the current position using the beacon signals not in the plain surface but by using the attitude information only.

If the beacon signal from the beacon device 120 has directivity and layout density so that the beacon signal does not affect a large error to the surface position, all of the three-dimensional position coordinates may be corrected. After correcting the current position, if the altitude information corresponds to a different floor, in S405, a new floor map and routes on the floor are acquired, the floor map displayed on the information processing apparatus 160 is updated, and the current position of the user is also displayed by superimposing the current position on the floor map.

In S406, after comparing position coordinates of the target destination with position coordinates of the current position, it is determined that whether or not both coordinates correspond with each other within a threshold value such as a predetermined distance etc. Hit is determined that both coordinates do not correspond (NO in S406), the operation in S406 is repeated until both coordinates correspond. If it is determined that the target destination corresponds to the current position (YES in S406), it is reported externally that the user has arrived at the target destination using graphics via the LCD, voice, or vibration in S407.

After that, it is determined whether or not the target destination is still registered in S407. If the target destination is not registered (NO in S407), the operation ends. If the target destination still exists (YES in S407), after receiving a command to start navigate the user to the next target destination by user 110′s operation in S409, the step proceeds to S403, the user 110 is navigated to the final target destination, and the operation ends.

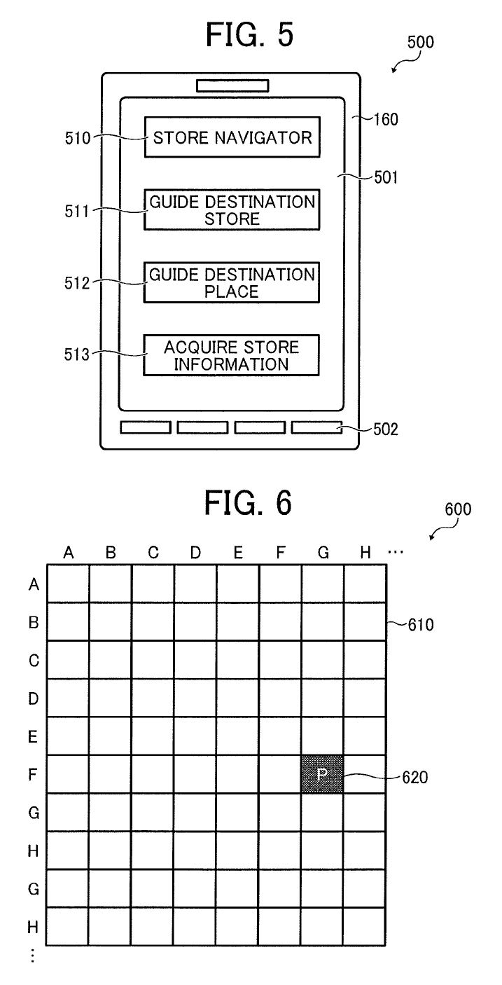

FIG. 5 is a diagram illustrating a graphical user interface (GUI) displayed by the information processing apparatus in this embodiment. For example, if the information processing apparatus 160 enters into the building 170, the information processing apparatus 160 downloads an application via the Internet and starts processing. The GUI displayed on the LCD 501 just after starting the application by user operation is illustrated in FIG. 5. On the LCD 501, menu items such as “store navigator” 510, “guide destination store” 511, and “guide destination place” 512, and “acquire store information” 513 are displayed.

At this point, since the user 110 is not sure of where the target store is located, the user 110 clicks the GUI of “acquire store information” 513. Each GUI is configured as a button, and an object associated with each GUI is called after the GUI is clicked by user operation. For example, if the user 110 clicks the GUI of “acquire store information” 513, in this embodiment, a decoder for a two-dimensional code is called.

FIG. 6 is a diagram illustrating a screen 600 such as a bulletin board when a two-dimensional bar-code such as QR code (registered trademark) is displayed in this embodiment with reference to FIG. 5. For example, as illustrated in FIG. 6, the bulletin board used for the screen 600 navigates the user to the target store. On the bulletin board, information on multiple stores is displayed two-dimensionally. For example, it is assumed that the user 110 intends to visit a store P. In this case, a two-dimensional code such as QR code (registered trademark) displayed at an appropriate area within a frame 620 is scanned using the camera of the information processing apparatus 160 by user operation and decoded.

It should be noted that the bulletin board in FIG. 6 may be implemented as a digital signage. In case of implementing the bulletin board as the digital signage, required information such as the floor map and position information etc. may be acquired using NFC, optical communication, and wireless communication such as Bluetooth etc. with a server or an information processing apparatus that provides the digital signage. Furthermore, in other embodiments, the digital signage is located at a basement parking area etc., and by providing position information and a floor map for each parking bay, it is possible to implement a navigation system for the parking area.

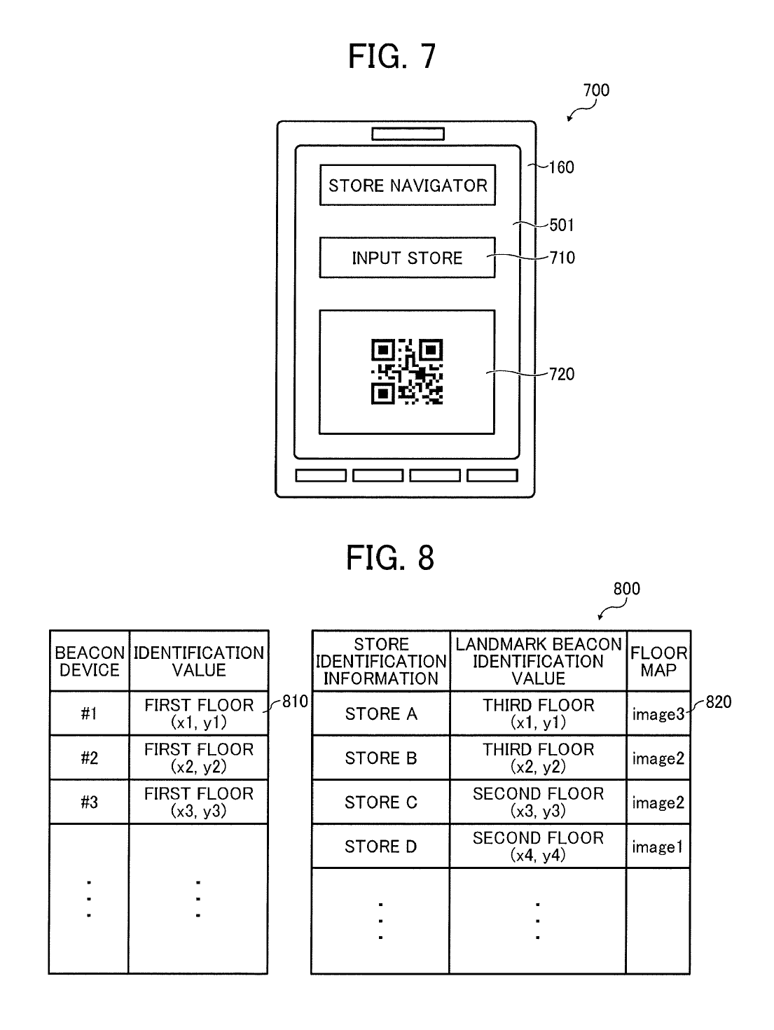

FIG. 7 is a diagram illustrating a screen 700 that the QR code (registered trademark) in the frame 620 is scanned by user 110's operation in the embodiment described above with reference to FIG. 6. On the LCD 501 of the information processing apparatus 160, a GUI “input store” 710 is displayed. The user 110 scans the QR code (registered trademark) in a scanning frame 720 to input store information. The QR code (registered trademark) at least includes position coordinates of the store inside the building 170. In other embodiments, the QR code (registered trademark) may include additional information on the store written in text. At this point, the information processing apparatus 160 may access the Internet and acquire the corresponding floor map.

FIG. 8 is a diagram illustrating a data structure 800 that building information is stored in a building information storing unit 308 in this embodiment. The building information storing unit 308 at lease stores beacon location information 810. In the beacon location information 810, individual identification information of the beacon device 120 is associated with position coordinates of the beacon device 120 located in the building 170. In addition to specifying the current position, the identification value of the beacon device 120 may be used as position information for specifying the target destination. Furthermore, the position coordinates or the individual identification information of the beacon device may be used for defining both end points that specify the route that the user 110 moves along.

In addition, the store information may be implemented as a store information table 820 associating a store name such as store A with the beacon device 120 that indicates a position of the store and a reference to the floor map corresponding to the target floor. In the below description, the beacon device 120 is referred to as a landmark beacon, and information that specifies the landmark beacon is referred to as a landmark beacon identification value. The landmark beacon device corresponds to a third beacon apparatus. After specifying the target destination by user 110's operation, using the store information acquired preliminarily, the information processing apparatus 160 stores information on the identification value of the landmark beacon associated with the store name in the guidance condition storing unit 305 and further acquires the floor map.

In addition, the guidance condition storing unit 305 stores information on specifying the way how to get to the target destination specified by user operation. Regarding specifying the way how to get to the target destination, it is possible to specify a first beacon device 120 when the user 110 accesses each floor and specify the route from the current position.

Furthermore, after acquiring the landmark beacon of the store as the target destination specified by the user 110, the information processing apparatus 160 specifies the beacon device indicating the current position, a route to a floor connecting position specified by the way how to move on the corresponding floor, and a route from the floor connecting position specified by the way how to move to the landmark beacon. The specified information is downloaded via the Internet, and superimposed on the route information for display as the floor map.

On the other hand, the PDR processor 306 calculates move of the user 110 from the current position using PDR method and updates the current position accordingly as the user 110 moves along. Furthermore, in this embodiment, if the beacon detector 304 detects the beacon device 120 whose identification value is new, the information on the current position acquired using PDR method is corrected using information received from the beacon devices 120 and 120a. With the corrected current position, errors due to calculation using PDR method are prevented from being accumulated, thus navigating the user in the building 170 more precisely.

Furthermore, in this embodiment, the floor level may be specified with reference to the identification value of the beacon device 120 using information on the floor where the beacon device 120 is located. This eliminates an error in identifying floors and provide high-precision floor navigation.

In the embodiment described above, an information processing apparatus that precisely navigates a user to a target destination even if the user uses an elevator, escalator, and stairs and moves between multiple floors in a building or in a basement is provided. In the embodiments described above, it is assumed that the building 170 is a commercial establishment such as a department store. However, in addition to the navigation system in the building 170, it is possible to adopt the navigation system in the embodiments to buildings integrating multiple functions such as a station, underground railway station, parking lot, underground shopping mall, large-scale facility, and university etc.

It should be noted that the embodiment described above does not limit scope of the present invention. It is possible to implement a multi-threading function that the print controller executes drawing threads and a bitmap image is generated concurrently in each of the drawing threads. In addition, it is possible to implement a multi-threading function that the communication controller executes drawing threads and a bitmap image is generated concurrently in each of the drawing threads.

In addition, it is possible that the image processing system includes multiple image forming apparatus and any one of the image forming apparatuses implements the function. The configuration of the image processing system in this embodiment is just an example, and it is possible to configure the image processing system in various ways depending on usage and purpose.

In this embodiment, it is possible to manage cache efficiently in multi-threading using two types of arrays, the tag value array dedicated to each thread and the cache data value array shared by all threads. The tag value array dedicated to each thread consists of the tag value and the value indicating the address that stores the cache data corresponding to the tag value. The cache data value array shared by all threads consists of the tag value and the cache data value corresponding to the tag value.

By using the tag value array dedicated to each thread, it is possible to provide the most appropriate cache to each thread and perform searching at high speed compared to a conventional method that uses the cache shared by all threads only. In addition, by using the cache data value array that stores data for the same tag values commonly, it is possible to minimize the memory size, and it takes only one calculation to acquire the calculation result from the tag value into the conversion result.

In the embodiment described above, an information processing system that can provide the most appropriate configuration of cache satisfying both the efficiency of searching through cache in multi-threading and the memory size is provided.

Numerous additional modifications and variations are possible in light of the above teachings. It is therefore to be understood that within the scope of the appended claims, the disclosure of the present invention may be practiced otherwise than as specifically described herein.

For example, elements and/or features of different illustrative embodiments may be combined with each other and/or substituted for each other within the scope of this disclosure and appended claims.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. An information processing apparatus comprising:
a receiver to receive position information indicating a position of a beacon device located inside a building, the beacon device including a first beacon device that transmits first position information and a second beacon device that transmits second position information, the second beacon device having narrower directivity compared to the first beacon device;
a sensor to detect a current position of the information processing apparatus; and
circuitry to:
acquire, in response to user operation for specifying a target destination, position coordinates of the target destination and a way how to get to the target destination;
measure the current position of the information processing apparatus using the first position information transmitted by the first beacon device;
update the current position of the information processing apparatus using pedestrian dead reckoning (PDR), based on detection of the sensor; and
correct altitude information of the current position using the second position information transmitted by the second beacon device.

2. The information processing apparatus according to claim 1,
wherein the second position information includes the altitude information of the current position, obtained at an area where the user approaches when the user moves to a different floor, and
the circuitry estimates a correction amount using PDR based on the second information transmitted by the second beacon device, and corrects the altitude information using the estimation.

3. The information processing apparatus according to claim 1,
wherein the second beacon device is located at an area where a user enters when the user moves into a different floor.

4. The information processing apparatus according to claim 1,
wherein the circuitry measures the current position using PDR based on information obtained as the user moves at least between the first beacon device and the second beacon device.

5. The information processing apparatus according to claim 1, further comprising:
a user interface to operate interactively with the user, the user interface being configured to request the user to input the target destination.

6. A navigation system, comprising:
the information processing apparatus of claim 1;
the first beacon device located inside a building that transmits first position information indicating a position of the first beacon device;
the second beacon device having narrower directivity compared to the first beacon device that transmits second position information indicating a position of the second beacon device; and
a third beacon device that is used for specifying the target destination.

7. A method of processing information performed by an information processing apparatus, the method comprising:
detecting a current position of the information processing apparatus;
acquiring, in response to user operation for specifying a target destination, position coordinates of the target destination and a way how to get to the target destination;
measuring the current position of the information processing apparatus using the first position information transmitted by the first beacon device;
updating the current position of the information processing apparatus using pedestrian dead reckoning (PDR), based on detection of the sensor; and
correcting altitude information of the current position using the second position information transmitted by the second beacon device.

8. A non-transitory, computer-readable recording medium storing a program that, when executed by one or more processors of an information processing apparatus, causes the processors to implement a method of processing information, comprising:
acquiring, in response to user operation for specifying a target destination, position coordinates of the target destination and a way how to get to the target destination;
measuring a current position of the information processing apparatus using the first position information transmitted by the first beacon device;
updating the current position of the information processing apparatus using pedestrian dead reckoning (PDR), based on detection of the sensor; and
correcting altitude information of the current position using the second position information transmitted by the second beacon device.

9. The information processing apparatus according to claim 2,
wherein the second beacon device is located at an area where a user enters when the user moves into a different floor.

10. The information processing apparatus according to claim 2,
wherein the circuitry measures the current position using PDR based on information obtained as the user moves at least between the first beacon device and the second beacon device.

11. The information processing apparatus according to claim 3,
wherein the circuitry measures the current position using PDR based on information obtained as the user moves at least between the first beacon device and the second beacon device.

12. The information processing apparatus according to claim 2,
wherein the second beacon device is located at an area where a user enters when the user moves into a different floor, and the circuitry measures the current position using PDR based on information obtained as the user moves at least between the first beacon device and the second beacon device.

13. The information processing apparatus according to claim 2, further comprising:
a user interface to operate interactively with the user, the user interface being configured to request the user to input the target destination.

14. The information processing apparatus according to claim 3, further comprising:
a user interface to operate interactively with the user, the user interface being configured to request the user to input the target destination.

15. The information processing apparatus according to claim 4, further comprising:
a user interface to operate interactively with the user, the user interface being configured to request the user to input the target destination.

16. The information processing apparatus according to claim 9, further comprising:
a user interface to operate interactively with the user, the user interface being configured to request the user to input the target destination.

17. The information processing apparatus according to claim 10, further comprising:
a user interface to operate interactively with the user, the user interface being configured to request the user to input the target destination.

18. The information processing apparatus according to claim 11, further comprising:
a user interface to operate interactively with the user, the user interface being configured to request the user to input the target destination.

19. The information processing apparatus according to claim 12, further comprising:
a user interface to operate interactively with the user, the user interface being configured to request the user to input the target destination.
